(19) United States
(12) Patent Application Publication
(10) Pub. No.: US 2012/0032550 A1
(43) Pub. Date: Feb. 9, 2012

(54) ELECTRIC CONNECTION OF CONDUCTOR ENDS ARRANGED IN PAIRS AND METHOD FOR ESTABLISHING THE CONNECTION

(75) Inventor: Gert Wolf, Affalterbach (DE)

(73) Assignee: ROBERT BOSCH GMBH, Stuttgart (DE)

(21) Appl. No.: 13/260,469

(22) PCT Filed: Feb. 10, 2010
(86) PCT No.: PCT/EP2010/051606

§ 371 Date: Oct. 31, 2011

(30) Foreign Application Priority Data
Mar. 25, 2009 (DE) 10 2009 001 850.6

(51) Int. Cl. H02K 3/28; H01R 43/02; H01R 4/02; B82Y 99/00

(52) U.S. Cl. 310/198; 174/94 R; 29/868; 977/755

(57) ABSTRACT

The invention relates to the electric connection of conductor ends (26b), which are arranged in pairs and are positioned on top of each other, of a winding comprising individual conductors and to a method for establishing the connection, wherein a plurality of the conductor ends in pairs are arranged next to each other at a distance (a). In order to establish the electric connection with the briefest and most spatially delimited heating possible, it is proposed to insert a nanofoil (30) between the conductor ends (26b) that are to be connected in pairs, to then press the conductor ends together to clamp the nanofoil (30), and to finally weld or solder the conductor ends to each other by igniting the nanofoil (30).

### BACKGROUND OF THE INVENTION

The invention relates to a method for making an electrical connection between paired conductor ends and to an electrical connection made using this method.

The document EP 0881 752 A1 discloses the practice of producing the stator winding in a three-phase generator for motor vehicles by electrically connecting together the conductor ends—situated above one another in pairs—of a stator winding comprising individual conductors. In this case, the connection is made by means of ultrasonic welding, arc welding, resistance welding, soldering or the like. However, such soldering or welding methods result in significant development of heat in the region and in the surroundings of the joint, with the drawback of possible damage to the adjacent regions, particularly to the insulation on the conductors.

The aim of the present invention is to make permanent electrical connection between paired conductor ends by means of brief action of heat which is limited as far as possible to the joint.

### SUMMARY OF THE INVENTION

An electrical connection of this kind is achieved by inserting a nanofoil between the conductor ends which are to be electrically connected to one another in pairs, then pushing the conductor ends together in order to clamp in the nanofoil, and then welding or soldering the conductor ends together by igniting the nanofoil. Accordingly, provision is made for a foil, subsequently called a nanofoil, which comprises at least one layer of chemical material reacting in a highly exothermic manner to be inserted between the conductor ends to be connected. Further details regarding the material, the properties thereof and the use thereof for connecting two parts to one another can be found in the document U.S. Pat. No. 7,354,659 B2.

Nanofoils are foils which are used to make a permanent connection between two workpieces. The nanofoils can make this connection by means of soft soldering, hard soldering or by means of diffusion welding. The operating principle of nanofoils is based on a highly exothermic reaction by chemical materials which are embedded in the foils. As a result, very high temperatures needed for soldering or welding are achieved briefly at the surface of the workpiece or the nanofoil. Since this heat is applied only over a very short period, however, the workpiece is not heated to excess. A known form of application of nanofoils is the connection of heat sinks to microprocessors in computers, for example.

The extremely high temperature which arises very briefly during what is known as ignition of the nanofoil starts to melt the material of the conductor ends which are to be connected to one another in the region of the nanofoil, so that, when pushed together, they are permanently welded to one another or, when a solder material is applied at that point, soldered to one another. This has the advantage that the welding operation can no longer result in damage to the lacquer insulation on the conductors in the region relatively close to the weld, which can sometimes mean a significant reduction in subsequent amendments or in production waste.

In order to produce a connecting surface area at the conductors ends to be connected which is bounded as exactly as possible but which is sufficient for the maximum current level, the conductor ends of the individual conductors having a rectangular cross section are positioned on edge so as to run parallel above one another and the nanofoil is inserted between the opposite narrow sides of the conductor ends. However, the individual conductors do not necessarily need to be positioned above one another so as to run parallel: the conductors can thus also be situated above one another at an angle of greater than zero, so that the conductors cross above the joint and preferably end at the boundary of the joint or project beyond the joint by a small amount. An expedient assembly aid for precisely positioning the nanofoils at the joints between the conductor ends involves a plurality of nanofoils being mounted onto a ribbonlike support at the distance from one another which is between the paired conductors ends arranged next to one another and being inserted together between the conductors ends which are to be connected in pairs. When the conductors ends have been welded or soldered, the ribbonlike support or the rest of the support material is removed. In order to keep the support material away from the contact region of the electrical connection between the conductor ends, the nanofoils are expediently mounted, preferably adhesively bonded, onto cutouts in a ribbonlike support designed in the manner of a comb. In this case, the width of the cutouts needs to be chosen to be slightly greater than the width of the conductor ends, and the nanofoils need to be of such a size that they cover the edges of the cutouts. Alternatively, it is proposed that the nanofoils have their front section mounted, preferably adhesively bonded, so as to protrude freely on one longitudinal side of the ribbonlike support. Similarly, it is possible to pack the nanofoils in a ribbonlike support of appropriate design.

In a further refinement of the invention, it is proposed that a plurality of nanofoils be connected to one another at a distance from one another via a web comprising the nanofoil material and thus be inserted together between the conductor ends which are to be connected in pairs. This solution allows a support to be dispensed with. A further advantage of this solution is that the webs between the nanofoils are used for successively igniting the nanofoils. It is merely necessary for a nanofoil to be ignited at one welding position in order to automatically ignite all welding positions in succession via the web. The nanofoils with the connecting webs can advantageously be produced without waste from a ribbonlike nanofoil strip by cutting the nanofoils out from the nanofoil strip so as to engage in one another in the manner of a comb.

In order to ensure permanent electrical connection between the paired conductor ends, provision is made that in the case of preferably lacquer-insulated individual conductors, insulation in the region of the narrow sides of the conductor ends which are to be connected to one another in pairs be removed, preferably by removing the conductor material, over the length of the nanofoil. In this case, the removal of the conductor material will expediently form a stop up to which the nanofoil is inserted between the conductor ends. The removal of the conductor material needs to be provided either at just one conductor end or at both conductor ends, with less conductor material than the thickness of the nanofoil being removed overall, so that when the conductor ends are pushed together it is ensured that the nanofoil is clamped in between the conductor ends. In order to make the electrical connection between the paired conductor ends after the nanofoil has been inserted, the conductor ends are expediently pushed together by piston rams. The nanofoil is then ignited by a pressure pulse acting thereon. Advantageously, the pressure pulse on the nanofoil is produced by a material spike which is integrally formed on a narrow side of the paired conductor ends in the region of the nanofoil. In order to reliably ignite the nanofoils, it is furthermore alternatively proposed that the nanofoils be ignited at a head region, the face of which protrudes between the paired conductor ends, by a heat pulse, preferably by a laser beam.

One advantageous application of the electrical connection according to the invention between paired conductor ends via nanofoils is obtained for electrical machines, particularly for three-phase generators for supplying power in motor vehicles, wherein the electrical connections are arranged on the winding head of their stator in a manner distributed evenly over the circumference. There, the individual conductors of the stator winding are inserted into the grooves in the stator sheet stack in a plurality of layers on edge above one another and have their sections which project from the grooves angled off at the side in opposite circumferential directions on the faces of the sheet stack. In the case of what are known as multilayer stator windings, there are in this case four, six or more conductor ends arranged above one another so as to be oriented parallel to one another, said conductor ends needing to be electrically connected to one another in pairs. In such arrangements, all conductor ends arranged above one another are expediently pushed together simultaneously by two piston rams and are then welded or soldered together in pairs by the nanofoils inserted between them. In order to facilitate the positioning of the nanofoils, provision is made for at least two ribbonlike supports to have their nanofoils which are arranged next to one another respectively inserted between the conductor ends that are to be connected in pairs. In this case, the ribbonlike supports must first of all be positioned relative to the joints so as to be at a distance of more than twice the conductor height from one another and then inserted axially with the nanofoils between the conductor ends which are to be connected in pairs.

### BRIEF DESCRIPTION OF THE DRAWINGS

Details of the invention are explained in more detail below by way of example with reference to the figures, in which:

FIG. 1 shows a three-phase generator for motor vehicles with a stator winding comprising individual conductors which are situated above one another in pairs,

FIG. 2 shows unwinding of the stator with the individual conductors angled off at the side on the winding heads of the stator winding,

FIG. 3 shows a three-dimensional detail from the front winding head with conductor ends arranged above one another in pairs and oriented parallel to one another,

FIGS. 4a) to e) show nanofoils which are preassembled at distances next to one another on ribbonlike supports or by connecting webs,

FIG. 5 shows the winding head detail from FIG. 3 with the preassembled nanofoils inserted between the paired conductor ends, as a first exemplary embodiment,

FIGS. 6a) to d) show different refinements of the paired conductor ends,

FIG. 7 shows a cross section through a plurality of conductor ends arranged next to one another and in pairs above one another on edge with two piston rams for making the electrical connection,

FIG. 8 shows a cross section through four conductor ends arranged on edge above one another with two piston rams for making two electrical connections on the two conductor pairs,

FIG. 9 shows, as a further exemplary embodiment, the three-dimensional detail from a winding head with two preassembled nanofoil ribbons between four conductor ends arranged above one another as shown in FIG. 8, and

FIG. 10 shows a cross section through an electrical connection made by a nanofoil between two conductor ends as shown in FIG. 7.

### DETAILED DESCRIPTION

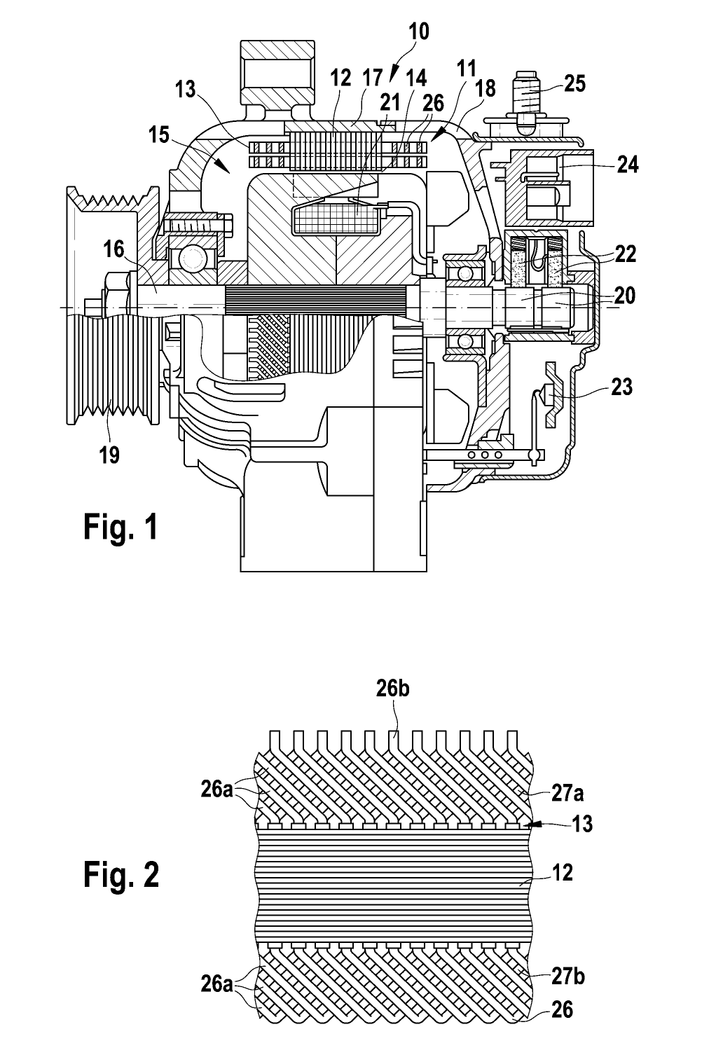

FIG. 1 shows a longitudinal section through an electrical machine as far as the central axis, said electrical machine being used as a three-phase generator 10 for supplying power in motor vehicles. It has a stator 11, the annular stator sheet stack 12 of which holds a three-phase stator winding 13 in its axial grooves arranged in an even distribution over the internal circumference. The stator winding 13 interacts via the stator sheet stack 12 and an operating air gap 14 with a claw-pole rotor 15, the rotor shaft 16 of which is mounted in two frames 17, 18 which simultaneously form the housing of the three-phase generator 10. The front of the rotor shaft 16 bears a pulley 19 by means of which it is driven via a pulley belt—not shown—of an internal combustion engine in the vehicle. The rear end of the rotor shaft 16 bears two sliprings 20 by means of which a field coil 21 of the claw-pole rotor 15 is supplied with field current via carbon brushes 22. The rear frame 18 also holds a rectifier unit 23 and a controller 24. The rectifier unit 23 is provided with the stator winding 13 on the input side and with a connection 25 for the positive potential of a motor vehicle electrical system on the output side. The controller 24 is used to control the level of the field current in the field coil 21 on the basis of the voltage from the vehicle electrical system.

The stator winding 13 comprises individual conductors 26 having a rectangular cross section. The individual conductors 26 are arranged in two layers on edge above one another in the grooves in the stator sheet stack 12. The sections 26a of the individual conductors 26—which sections are shown in more detail in FIG. 2 and protrude on the faces of the stator sheet stack 12—form a respective winding head 27a and 27b at that point.

FIG. 2 shows a portion of the unwinding of the stator sheet stack 12 from FIG. 1 with the two winding heads 27a and 27b of the stator winding 13. The individual conductors 26 are preformed in a hairpin shape and have one limb inserted in the lower position of a groove in the stator sheet stack 12 and have their other limb inserted in an upper position of another groove, both grooves being spaced apart from one another by what is known as a winding step. The sections 26a of the individual conductors 26—which sections protrude on the faces of the stator sheet stack 12—first of all emerge in pairs above one another from the grooves in the stator sheet stack 12, from where they are angled off at the side in opposite circumferential directions. Whereas, on the lower winding head 27b, the individual conductors 26 are each transferred from the upper position to the lower position by means of the angling, the conductor ends 26b of the individual conductors 26 on the upper winding head 27a are oriented axially such that they are above one another on edge in pairs and in this case run parallel to one another.

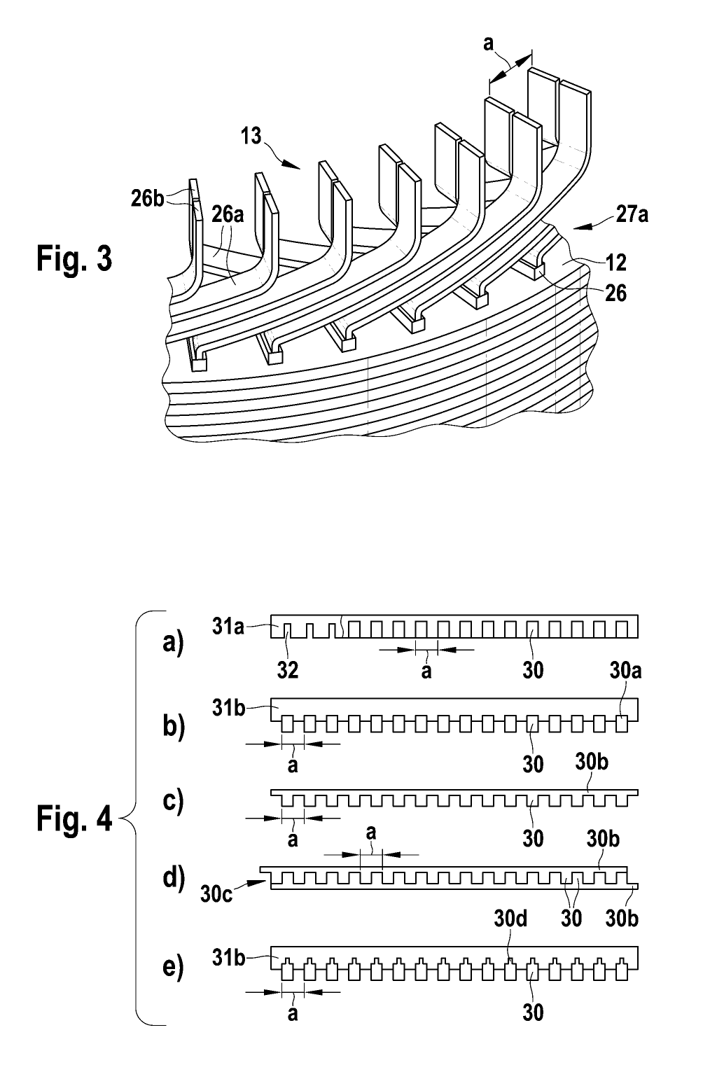

FIG. 3 shows an enlarged three-dimensional illustration of a section of the upper winding head 27a with the stator sheet stack 12. In this case, it can be seen that the sections 26a of the individual conductors 26 which protrude from the stator sheet stack 12 are angled off to the right in the outer position of the grooves, whereas the sections 26a of the individual conductors 26 are angled off to the left in each case in the inner position. It can also be seen how the axially oriented conductor ends 26b are arranged next to one another in pairs at a distance a, the conductor end pairs being situated on edge above one another and at the same time being oriented parallel to one another.

To produce the stator winding, the conductor ends 26b need to be electrically connected to one another in pairs. To this end, the method according to the invention is used to insert a nanofoil—in a manner which will be described in more detail below—between the paired conductor ends which are to be electrically connected to one another, and then the conductor ends 26b are pushed together in pairs. In the thus clamped-in state, the nanofoil is then ignited and this welds or solders the conductor ends 26b together.

FIG. 4 shows various options which are used to preassemble nanofoils 30 such that they are mounted onto a ribbonlike support 31 comprising paper, plastics or another sufficiently robust material at the distance a from one another which is between the paired conductor ends arranged next to one another.

As shown in FIG. 4, part a), to this end the ribbonlike support 31a is provided with cutouts 32 which are open at the bottom and which are at the same distance a from one another as the respectively adjacent paired conductor ends 26b shown in FIG. 3. These cutouts 32 in the support 31a designed in the manner of a comb can be seen on the left-hand side in part a) of FIG. 4. The nanofoils 30 are mounted, preferably adhesively bonded, on the support 31a in the region of the cutouts 32. In this case, the width of the cutouts 32 is slightly greater than the width of the conductor ends 26b in order to prevent the support 31a from also being clamped in between the conductor ends 26b which are to be connected to one another. By contrast, the nanofoils 30 are designed to be of a size such that they cover the edges of the cutouts 32, as can be seen in part a) of FIG. 4. As part b) shows, a ribbonlike support 31b without cutouts 32 is used in which the nanofoils 30 have their front section 30a adhesively bonded so as to protrude freely on one longitudinal side of the ribbonlike support 31b. In this embodiment, the nanofoils 30 are inserted between the paired conductor ends 26b not completely but rather with the exception of their front section 30a, so that the ribbonlike support 31b is not clamped in between the conductor ends 26b. As part c) of FIG. 4 shows, the nanofoils 30 are connected to one another at a distance a from one another via a respective web 30b comprising the nanofoil material, so that the webs in this case are the ribbonlike support 31 for the nanofoils 30. As part d) shows, the nanofoils 30 with the webs 30b from part c) can be produced in pairs without waste from a ribbonlike nanofoil strip 30c by cutting them out from the nanofoil strip 30c so as to engage in one another in the manner of a comb. In the case of this solution, the nanofoils 30 can be inserted together completely between the conductor ends 26b which are to be conducted in pairs. The particular advantage of this solution is that igniting one nanofoil 30 automatically ignites the other nanofoils in succession via their respective web 30b. In a further embodiment as shown in FIG. 4, part e), the nanofoils 30 are mounted on the lower edge of the ribbonlike support 31b at the distance a in the same way as in part a) or b). In this case, however, the nanofoils 30 have a head 30d which protrudes at the top. When the nanofoils 30 have been inserted between the paired conductor ends 26b, this head 30d protrudes to such an extent that the nanofoils 30 can be ignited individually at that point by a heat pulse, for example by a laser beam.

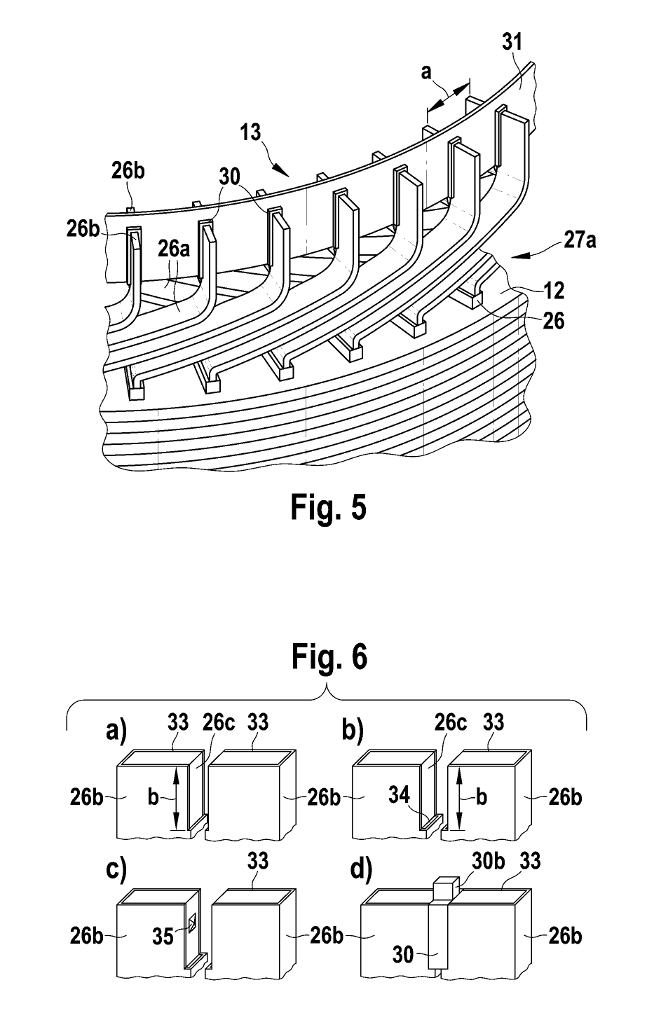

FIG. 5 again shows a three-dimensional illustration of the detail from the winding head 27a which is depicted in FIG. 3, but in this case the nanofoils 30 have now been mounted onto the ribbonlike support 31a at the distance a from one another which is between the paired conductor ends 26b arranged next to one another and have been inserted together between the conductor ends 26b which are to be connected in pairs. In this case, the nanofoils 30 are each arranged between the opposite narrow sides of the paired conductor ends 26b arranged on edge above one another.

In order to ignite the nanofoils 30 and to weld the paired conductor ends 26b together, it is necessary to subject the conductor ends 26b to preliminary treatment in suitable fashion. FIG. 6 shows various alternatives for the preliminary treatment of the paired conductor ends 26b. Since the individual conductors 26 of the stator winding 13 are usually covered by an insulating lacquer 33, part a) of FIG. 6 shows that the insulating lacquer 33 is removed at least over the insertion length b of the nanofoil 30 in the region of the narrow sides 26c of the conductor ends 26b which are to be connected to one another in pairs. In accordance with the embodiment shown in FIG. 6, part b), conductor material is removed over the insertion length b of the nanofoil 30 on this region of the narrow sides 26c at the conductor ends 26b. In this case, the removal of the conductor material produces a stop 34 on the narrow sides 26c of the conductor ends 26b, up to which stop the nanofoil 30 is inserted between the conductor ends 26b. However, the removal of conductor material must be less than the thickness of the nanofoil 30 for both conductor ends 26b overall. As an alternative to the embodiment shown in FIG. 6, part b), it may be sufficient to provide the stop 34 only at one of the two conductor ends 26b and merely to remove the insulating lacquer 33 on the opposite narrow side 26c of the other conductor end 26b. Furthermore, as FIG. 6, part c) shows, one of the two narrow sides 26c of the conductor ends 26b can have a material spike 35 integrally formed on it, for example by embossing, which is used to specifically produce a pressure pulse for igniting the nanofoil 30. In the arrangement shown in FIG. 6, part d), a nanofoil 30 with an outwardly protruding head 30d as shown in FIG. 4, part e), has been inserted between two conductor ends 26b designed as shown in part b). In this case, it can be seen that the nanofoil 30 is thicker than the total removal of conductor material on the narrow sides 26c of the two conductor ends 26b.

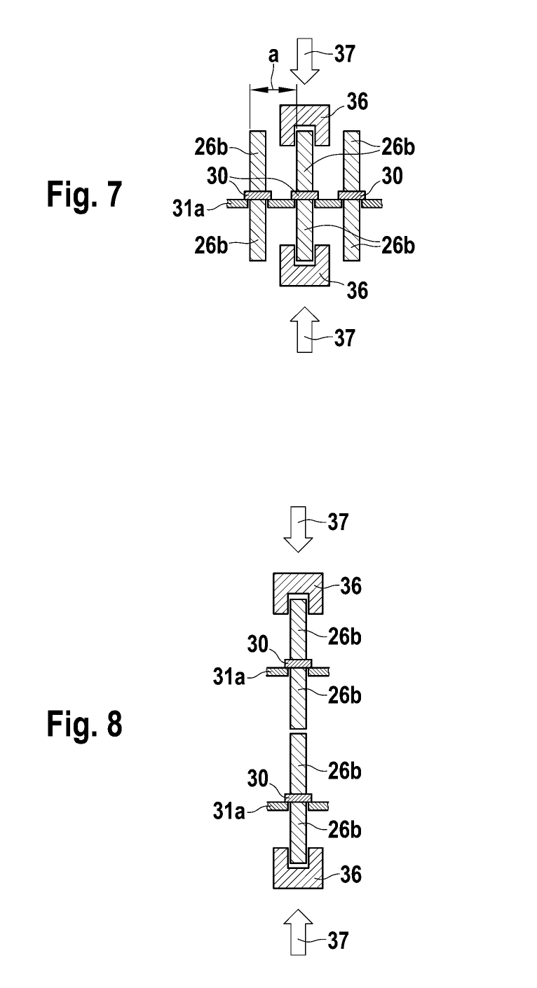

FIG. 7 shows a cross section through a plurality of conductor ends 26b arranged in pairs at a distance a next to one another, as corresponds to the arrangement shown in FIG. 5. The ribbonlike support 31a with the nanofoils 30 has been inserted between the upper and lower conductor ends 26b, the nanofoils 30 each being situated between the opposite narrow sides of the paired conductor ends 26b arranged on edge above one another. Arranged above and below the central two conductor ends 26b is a respective piston ram 36. These piston rams 36 are used to push together the two conductor ends 26b in the direction of the arrows 37 and hence to firmly clamp in the nanofoil 30 situated between them. Finally, the nanofoil 30 is then ignited by a pressure pulse which is produced by the piston rams 36 and acts on the nanofoil 30. The ignition of the nanofoil 30 briefly produces a heat pulse throughout the nanofoil 30, said heat pulse welding together the two conductor ends 36b on their narrow sides 36c. As an alternative, it is also possible for the conductor ends 26b to be soldered together. In this case, however, the conductor ends 26c must first of all be prepared as appropriate by applying solder material to their narrow sides 26c. Instead of the ribbonlike support 31a shown in part a) of FIG. 4, the nanofoils 30 can also be inserted, in an arrangement as shown in part b), c) or e) of FIG. 4, in a preassembled state between the conductor ends 26b which are to be connected in pairs. When the nanofoils 30 shown in FIG. 4, part c) have each been connected to one another via a web 30b, it is first of all necessary for all conductor ends 26b which are to be connected to one another to be pushed together in order to clamp in the nanofoils 30 before one of the nanofoils 30 or a web 30b is ignited. The remaining nanofoils 30 are then each automatically ignited in succession via the web 30b.

In FIG. 8, four conductor ends 26b are arranged above one another, said conductor ends being arranged parallel to one another in pairs. Inserted between the conductor ends 26b to be connected to one another in pairs is a respective nanofoil 30 which is mounted on a ribbonlike support 31a as shown in FIG. 4, part a). Arranged above and below the four conductor ends 26barranged on edge above one another is a respective piston ram 36, which is used to push together the four conductor ends 26b in the direction of the arrows 37. In this case, the two nanofoils 30 are clamped in between their paired conductor ends 26b. Both nanofoils 30 are then simultaneously ignited by a pressure pulse produced by the piston rams 36, as a result of which the conductor ends 26b are welded or soldered together in pairs.

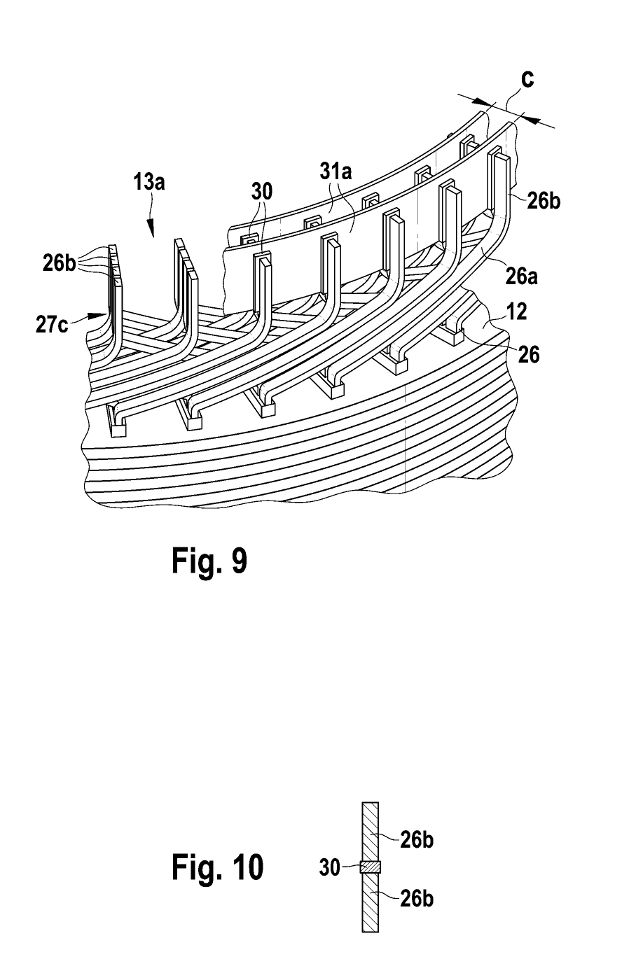

FIG. 9 shows the use of four conductor ends 26b which are situated on edge above one another and which are intended to be connected to one another in pairs, specifically using a three-dimensionally presented section of a winding head 27c with the conductor ends 26b of a multilayer stator winding 13a. In this case, two ribbonlike supports 31a as shown in FIG. 4, part a), with nanofoils 30 arranged next to one another are inserted between the conductor ends 26b which are to be connected in pairs. In that case, it is possible to see that, just as in FIG. 8, the upper conductor pair 26b and the lower conductor pair 26b are at a distance from one another in order to avoid winding or phase shorts, as a result of which the two ribbonlike supports 31a are at a distance c from one another which is more than twice the conductor height of the conductor ends 26b. When all conductor ends 26b have been welded together in pairs via nanofoils 30, a further step involves the ribbonlike supports 31a or residues of the support material which are still present being removed. In the simplest case, the ribbonlike supports 31a can be removed completely simply by brushing down the winding heads.

Finally, FIG. 10 shows a cross section through an electrical connection between two conductor ends 26b situated above one another, where the two conductor ends 26b which are situated on edge above one another and which are oriented parallel to one another have been welded together by a nanofoil 30 which is arranged between the conductor ends 26b and has been ignited as shown in the arrangement from FIG. 7. The conductor ends 26b on the winding head 27c of the three-phase generator 10 or on other electrical machines therefore also need to be produced accordingly, in so far as the windings thereof comprise individual conductors 26, the conductor ends 26a of which are welded or soldered together in pairs. In order to protect the joints, the conductor ends are expediently covered again after brushing down by sprinkling them with or immersing them in impregnating resin.

The invention is not limited to the exemplary embodiments shown and described, since, instead of a rectangular cross section for the conductor ends, said cross section may equally well be square or polygonal in form. However, it is essential in this context that the nanofoil 30 is clamped in flat between the conductor ends and ignited. In addition, it is possible for the paired conductor ends to be placed not on edge but rather flat on top of one another, and the ignition of the nanofoils 30 should then expediently be effected by means of a material spike as shown in FIG. 6c or externally by a laser beam or the like. When individual conductors are used in electrical machines, it is likewise possible, as a departure from the embodiment shown in FIG. 2, for both winding heads of the machine to have conductor ends welded or soldered together in pairs. The method according to the invention can be applied not only to the winding heads in electrical machines but also to transformers and other electrical devices or appliances, provided that conductor ends need to be electrically connected to one another in pairs therein.

1. A method for making an electrical connection between conductor ends (26b)—which are situated above one another in pairs and are oriented with respect to one another—of a winding (13) which comprises individual conductors (26), and in which the individual conductors are arranged in a plurality of layers above one another, wherein a plurality of the paired conductor ends are arranged next to one another at a distance (a), the method comprising inserting a nanofoil (30) between the conductor ends (26b) which are to be electrically connected to one another in pairs, then pushing the conductor ends (26b) together in order to clamp in the nanofoil (30), and then welding or soldering the conductor ends (26b) together by igniting the nanofoil (30).

2. The method as claimed in claim 1, characterized in that the nanofoil (30) is inserted between opposite narrow sides (26c) of paired conductor ends (26b) which are arranged on edge above one another.

3. The method as claimed in claim 1, characterized in that a plurality of nanofoils (30) are mounted on a ribbonlike support (31) at the distance (a) from one another which is between the paired conductor ends (26b) arranged next to one another and are inserted together between the conductor ends (26b) which are to be connected in pairs, and in that the support (31) or in that support material is removed when the conductor ends (26b) have been welded or soldered.

4. A method as claimed in claim 3, characterized in that the nanofoils (30) are mounted, onto cutouts (32) in a support (31a) designed in the manner of a comb, wherein the width of the cutouts (32) is chosen to be slightly greater than the width of the conductor ends (26b), and wherein the nanofoils (30) are designed to be of such a size that they cover the edges of the cutouts (32).

5. The method as claimed in claim 3, characterized in that the nanofoils (30) have their front section (30a) mounted, so as to protrude freely on one longitudinal side of the ribbonlike support (31a).

6. The method as claimed in claim 2, characterized in that a plurality of nanofoils (30) are connected to one another at a distance (a) from one another via a web (30b) comprising the nanofoil material and are inserted together between the conductor ends (26b) which are to be connected in pairs.

7. The method as claimed in claim 6, characterized in that the nanofoils (30) and webs (30b) are cut out from a ribbon like nanofoil strip (30c) so as to engage in one another in the manner of a comb.

8. The method as claimed in claim 6, characterized in that igniting one nanofoil (30) automatically ignites the other nanofoils (30) via the web (30b) in succession.

9. The method as claimed in claim 1, characterized in that in the case of lacquer-insulated individual conductors (26b), insulation (33) in the region of the narrow sides (26c) of the conductor ends (26b) which are to be connected to one another in pairs is removed, by removing conductor material, over at least the insertion length (b) of the nanofoil (30).

10. The method as claimed in claim 9, characterized in that the removal of the conductor material at the conductor end (26b) forms a stop (34) up to which the nanofoil (30) is inserted between the conductor ends (26b), and in that in the process less material than the thickness of the nanofoil (30) is removed overall at only one conductor end or at both conductor ends(26b).

11. The method as claimed in claim 1, characterized in that the conductor ends (26b) to be connected to one another in pairs are pushed together by piston rams (36) following the insertion of the nanofoil (30), and in that the nanofoil (30) is then ignited by a pressure pulse acting thereon.

12. The method as claimed in claim 11, characterized in that the pressure pulse on the nanofoil (30) is produced by a material spike (35) which is integrally formed in the region of the nanofoil on a narrow side (26c) of the paired conductor ends (26b).

13. The method as claimed in claim 1, characterized in that the nanofoils (30) are ignited at a head (30d), the face of which protrudes between the paired conductor ends (26b), by a heat pulse.

14. The method as claimed in claim 1, characterized in that at least four conductor ends (26b) which are oriented with respect to one another are arranged above one another, are simultaneously pushed together by the piston rams (36) and are then welded or soldered together in pairs by the nanofoils (30).

15. The method as claimed in claim 3, characterized in that at least two ribbonlike supports (31a) with nanofoils (30) arranged next to one another are each inserted between the conductor ends (26b) which are to be connected in pairs at a distance of more than twice the conductor height from one another.

16. An electrical connection between conductor ends (26b)—which are situated above one another in pairs and are oriented with respect to one another—of a winding (13) which comprises individual conductors (26), wherein a plurality of the conductor ends to be connected in pairs are arranged next to one another at a distance (a), characterized in that the conductor ends (26b) situated above one another are welded or soldered together in pairs via a nanofoil (30) which is arranged between said conductor ends and which is ignited, in accordance with the method as claimed in claim 1.

17. A three-phase generator (10) for supplying power in motor vehicles, characterized in that the electrical connections are made between conductor ends (26b) which are arranged above one another in pairs on the winding head (27) of their stator (11) in accordance with the method as claimed in claim 1.

18. A method as claimed in claim 1, characterized in that the individual conductors (26) have a rectangular cross section, and the individual conductors are arranged in a plurality of layers above one another, in grooves in a sheet stack (12), and are angled at a side in opposite directions on at least one end face of the sheet stack,

19. A method as claimed in claim 3, characterized in that the nanofoils (30) are adhesively bonded onto cutouts (32) in a support (31a) designed in the manner of a comb, wherein the width of the cutouts (32) is chosen to be slightly greater than the width of the conductor ends (26b), and wherein the nanofoils (30) are designed to be of such a size that they cover the edges of the cutouts (32).

20. The method as claimed in claim 3, characterized in that the nanofoils (30) have their front section (30a) adhesively bonded so as to protrude freely on one longitudinal side of the ribbonlike support (31a).
